(19) United States
(12) Patent Application Publication
(10) Pub. No.: US 2006/0150819 A1
(43) Pub. Date: Jul. 13, 2006

(54) Electro-optical air purifier with ionizer

(76) Inventor: Se Kit Yuen, Hong Kong (CN)

Correspondence Address: ARTHUR KING MA, 1030 CORONADO DRIVE, ARCADIA, CA, 91007, US

(21) Appl. No.: 11/079,746

(22) Filed: Mar. 14, 2005

(30) Foreign Application Priority Data
Jan. 8, 2005 (HK) 05100175.2

(51) Int. Cl. B01D 46/00

(52) U.S. Cl. 96/224

(57) ABSTRACT

This invention relates to an air purifier that uses both transportation vehicles battery and conventional indoor power supply, more particularly to an air purifier which employ UV tube to generate UV with wavelength of 253.7 nanometers, electronic circuit system is characterized by a high negative voltage output volume as stated, i.e. within the range of 4.5 kv and 8.5 kv which is able to kill bacteria, virus and mildew in the air while emits negative ions into the environment. This air purifier draws indoor air in and out of the air purifier, kills bacteria, viruses and moulds in the air and discharges electricity by means of negative high voltage output through carbon fibers to produce anions, so as to improve the quality of the air.

### REFERENCE CITED

Applicant prays to cross reference for his related applications i.e. application Ser. No. 10/890,344 filed on Jul. 12, 2004 now pending and application Ser. No. 10/888,116 filed on Jul. 9, 2004 now pending.

### BACKGROUND OF THE PRESENT INVENTION

The present invention relates to an air purifier, more particularly to an air purifier which employ UV tube to generate UV with wavelength of 253.7 nanometers, which is able to kill bacteria, virus and mildew in the air while emits negative ions into the environment.

1. Field of Invention

Most conventional air purifiers require normal indoor power supply such as 220V or 120 volt depending on geographical limitation, while few of those are designed mainly for transportation vehicles, which allow air purifier to function under a power supply generated by automobile, i.e. 12 volt, as transportation vehicles are operating. Almost no conventional air purifier has the ability providing capacity for both indoor power supply and automobile power supply.

Numerous air filters have been provided in prior art. For example, U.S. Pat. No. 3,967,927, U.S. Pat. No. 4,210,429; U.S. Pat. No. 5,171,060 and U.S. Pat. No. 5,330,722 all are illustrative of such prior art. While these units may be suitable for the particular purpose to which they address, they would not be as suitable for the purposes of the present invention as heretofore described.

As disclosed in U.S. Pat. No. 3,967,927, an ultraviolet lamp fixture for purifying the air within a room by means of passing the air over a plurality of hot cathode or other commercially available ultraviolet ray tubes. The tubes are mounted vertically within a decoratively covered, easily movable, pole-mounted housing having a motorized fan, which moves air through an opening in the lower portion of the housing over the tubes for purification. The purified air stream is exhausted through the top body portion of the housing and returned to the room. The interior of the housing has deflector vanes which function to create a turbulent airflow in the area of the tubes to insure that contacting the lamps purifies all of the air passing through the lamp fixture. The lamp fixture is provided with means for filtering the circulating air. In an alternate embodiment, the air passes through a dehumidifier prior to passing by the tubes.

Furthermore, U.S. Pat. No. 4,210,429, a room air purifier for quietly removing irritating or harmful impurities from the air circulating within the room. The purifier removes from room air, particles down to 0.3 microns in size with 99.9% efficiency. The air purifier comprises a somewhat elongated upright housing having an easily-removable back, a two-speed blower that is preferably AC operated and disposed at the bottom body of the housing, a pair of vertically disposed ultraviolet lamps and associated means for powering the lamps including push button switch means, and preferably three separate filters including a pre-filter disposed at the inlet of the blower, a highly efficient main filter element vertically stacked over the blower and lamps and a charcoal filter disposed over the main filter element. The blower sucks the air in the bottom body of the purifier through the pre-filter and up adjacent to the lamps to the main filter element and charcoal filter, and from there the purified air passes to a top body baffle cover where the air is exited in preferably four directions from the purifier.

In U.S. Pat. No. 5,171,060, an ornament-displaying article of furniture having a weight-bearing surface member and pedestal base has a supporting substantially cylindrical and preferably transparent column releasable connected to the weight-bearing surface member. The appearance of the column may be altered with an agglomeration or reflective fill material, such as marbles, which may be exchanged by detaching the column from the weight-bearing surface member. In a preferred embodiment a light source irradiates light reflective or light radiant material of the fill.

In U.S. Pat. No. 5,330,722 a germicidal air purifier for trapping and destroying airborne microorganisms is disclosed. The air purifier includes an ultraviolet radiation source and a juxtaposed filter medium. One ultraviolet radiation source and filter medium is fixed and the other is displaceable, so that at least an upstream side of the filter medium is systematically exposed to germicidal levels of radiation. In a first preferred embodiment, a fixed ultraviolet lamp irradiates a cylindrical air filter, which is rotated on its longitudinal axis in close proximity to the lamp, so that the upstream side of the filter is systematically irradiated. In a second preferred embodiment, a radiant lamp fixture is moved reciprocally across an upstream side of a planar filter, to systematically irradiate the filter. In a third preferred embodiment, a radiant lamp fixture is rotated about an axis, which is orthogonal to its longitudinal midpoint, so that a circular area of a planar filter is irradiated. The advantage is that microorganisms trapped on the filters are exposed to a lethal dose of radiation and the air purifier is consistently effective at destroying a significant percentage of airborne microorganisms suspended in the air passed through the filter.

In addition, most conventional air purifiers can only separate unwanted airborne particles from air to achieve so-called purification for air. However, this is a well known fact that anions in the air are good for health. It would be beneficial should air purifiers can produce anions while separating unwanted airborne particles from air allows.

2. Description of Related Arts

### SUMMARY OF THE PRESENT INVENTION

A main object of the present invention is to provide an air purifier has the ability providing capacity for both indoor power supply and automobile power supply.

A main object of the present invention is to provide an air purifier which employ UV tube to generate UV with wavelength of 253.7 nanometers, which is able to kill bacteria, virus and mildew in the air while emits negative ions into the environment.

Another object of the present invention is to provide an air purifier can produce anions while separating unwanted airborne particles from air flows.

Accordingly, in order to accomplish the above objects, the present invention provides an air purifier, which comprises:
an air ventilator,
an UV emission tube, and negative high voltage electrical carbonization fiber, wherein, when air is drawn into said air purifier through its ventilator, it goes through two different constant circulating processes; and
said circulating process further comprises:
a first process is to exercise negative high voltage on carbonization fiber to discharge electricity, thus creates negative ions and then emanates the air through vent; and
a second process sets off UV to kill bacteria, virus and mildew, there is a one incoming air vent and one outgoing air vent; said high voltage carbonization fiber is fixed inside of an outgoing air vent, while said UV emission tube is located within said incoming air vent; said air ventilator is positioned inside of said air purifier, taking in regular air with bacteria, virus, and mildew to said air purifier, thereby it drives the moving air through said air purifier, forcing air with bacteria, virus and mildew to contact said UV tube, so that UV could perish bacteria, virus and mildew first, and then it pushes the air through the purification process of negative ionization and finally emanates fresh air with negative ion to improve the indoor air quality.

### BRIEF DESCRIPTION OF THE DRAWINGS

FIG. 1 is a side view of the present invention.

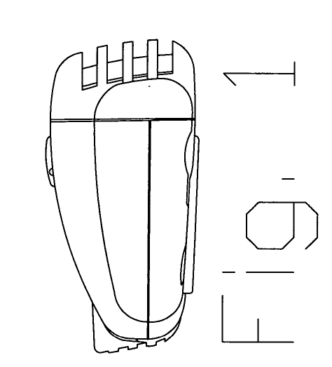

FIG. 2 is a side sectional view thereof.

FIG. 3 is a plan sectional view thereof.

FIG. 4 is a front view thereof.

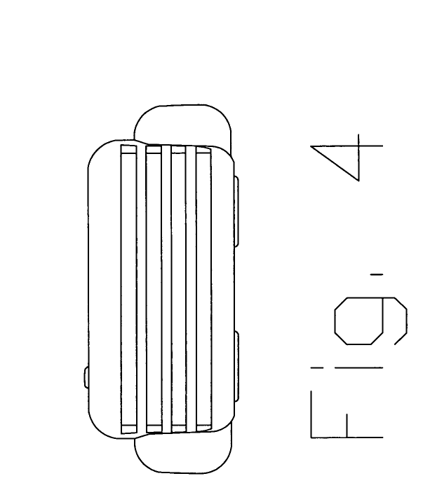

FIG. 5 is a rear view thereof.

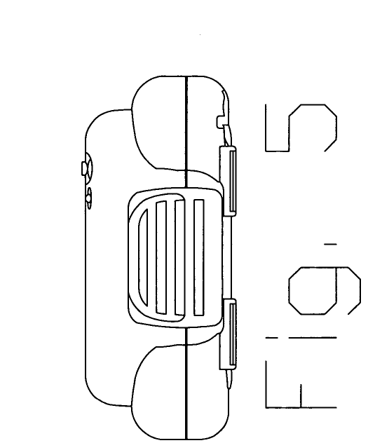

FIG. 6 is another side view thereof.

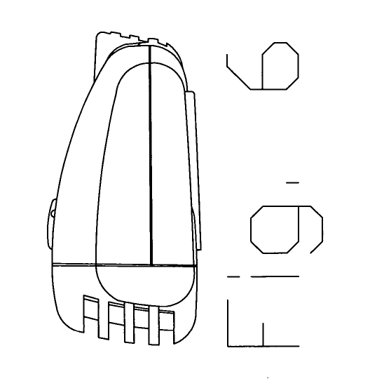

FIG. 7 is an underneath view thereof.

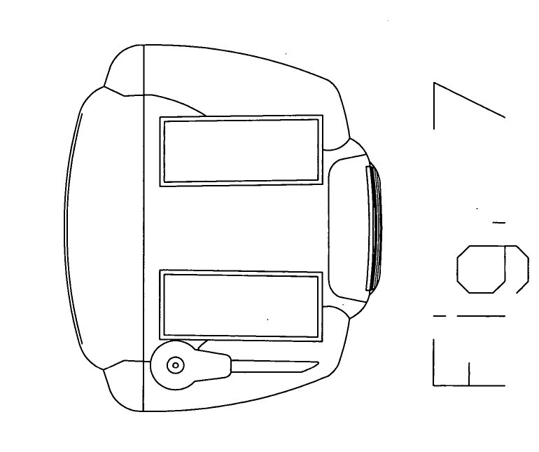

FIG. 8 is a plan view thereof.

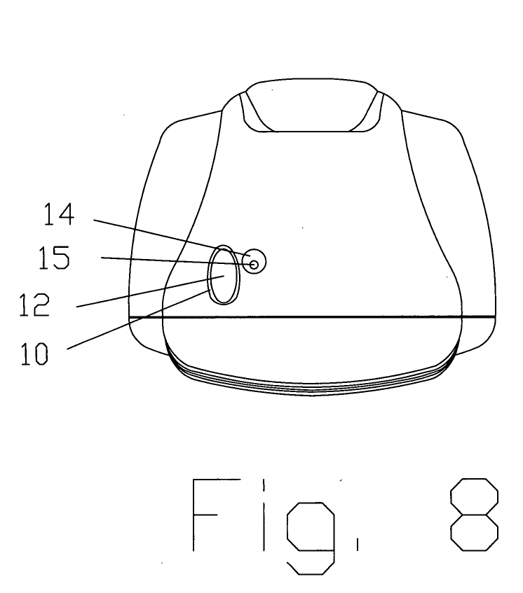

FIG. 9 is a front isometric view thereof.

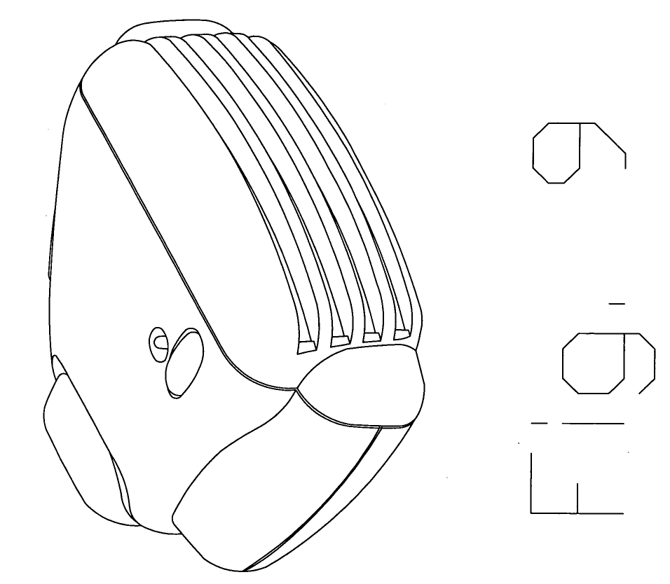

FIG. 10 is a rear isometric view thereof.

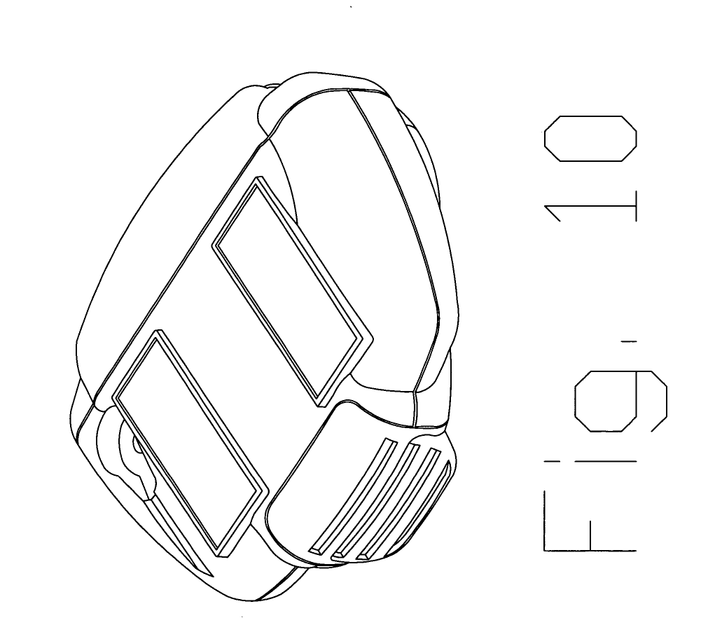

### DETAILED DESCRIPTION OF THE PREFERRED EMBODIMENT

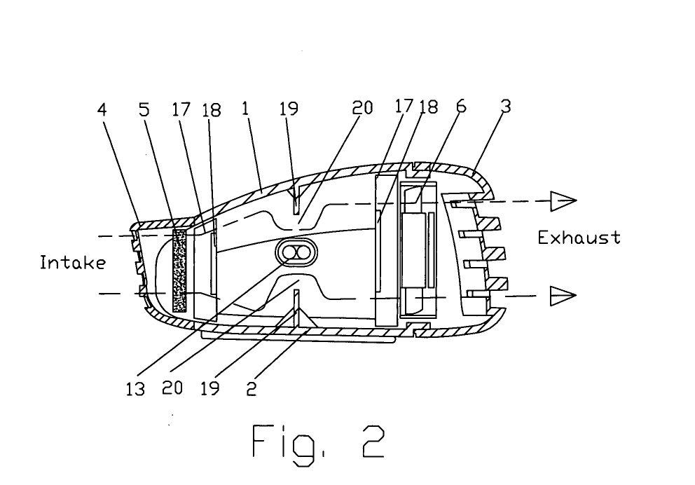

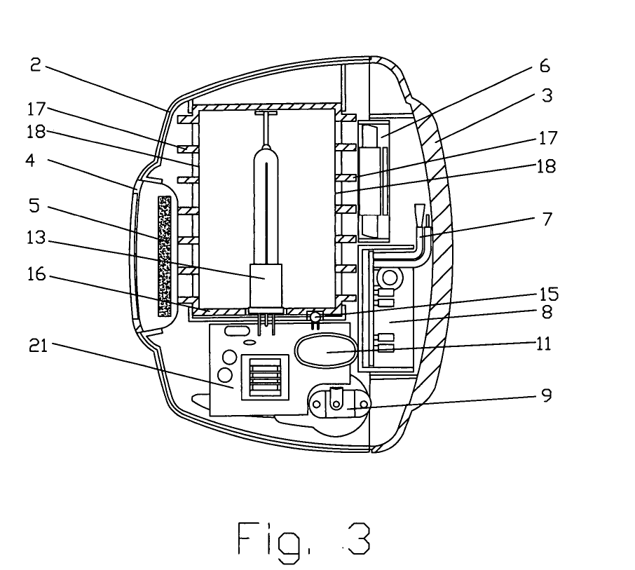

This present invention has a rectangular shaped body with top body (1) and bottom body (2). It also has an arc shaped air outgoing lattice (3) which is an outlet of ionized air. Referring to FIG. 2 and FIG. 3, structure of this electro-optical air purifier is illustrated. At a rear portion of said top body (1) and said bottom body (2) of said purifier, there is an incoming air lattice (4). Said incoming air lattice (4) provides a fixed dust filter (5) for an incoming air vent. Glued to a top body surface of said air outgoing lattice (3) is an air ventilator (6). A carbonization fiber (7) is affixed in a center portion on rear surface of said air outgoing lattice (3). Via negative high voltage, said carbonization fiber (7) creates ionized air. An electron generator (8) is installed on side edge of said air ventilator (6). It connects to an external power outlet (9) through a power cord on a base (2) of said purifier.

On upper portion of said top body (1) there is a rectangular round hole (10) whereby on/off switch cover (11) is affixed at. At lower portion of said bottom body (2), on/off switch cover (11) is closely glued to a switch (12). Said switch (12) controls various functions of air ventilator (6), an UV emission tube (13) and said carbonization fiber (7). On said upper portion′ surface of said top body (1) there is a round hole (14) to fix different color of illuminating diodes (15), which are used as functional indicators. Said switch (12) and said illuminating diodes (15) are fastened to a photoelectron UV radiation circuit device (21) at said bottom body (2) of said air purifier.

In practice, when activating said air purifier, said air ventilator (6) draws air with bacteria, virus and mildew through dust filtration screen (5), moves them into an air collectors (16) which are inside of said top body (1) and said bottom body (2) of said air purifier. At both front and back ends of said air collector (16), there are many strip frames (17) which guide moving air through air collector (16) to an outgoing air lattice (3). In a center portion of said strip frames (17) there is a blocking wall (18). UV emission tube (13) is located at a center portion of said air collector (16). In other words, air contains bacteria, virus, mildew travels into both front and back ends of said air collector's (16) collecting pockets (18), then moves into an air intake vent (20) which is located between UV emission tube (13) and collecting pockets (16). Therefore when air goes though air intake vent (20), bacteria, virus, and mildew are killed by UV emitted from the UV emission tube (13). Purified air will then leaves via said ventilator (6) to outgoing lattice's (3) negative high voltage carbonization fiber (7) is ionized. At a result, ionized fresh air is released through said outgoing air lattice (3) to improve indoor air quality.

There are blocking wall (18) at both said top body (1) and said bottom body (2) of said air collector (16). Said blocking wall (18) is to prevent emission of UV radiation outside of the appliance and is for protecting the user's eyes.

Said air purifier is having a circuitry theory which receives power from the AC or car battery through the external outlet (9). Input power passes through on/off switch (12) to a circuitry of negative ion generator to provide a negative high voltage output. An output power goes through a rectifier providing power to ventilator (6), and said circuitry that exchange DC and AC, activating circuitry for UV emission tube (13). Another one provides power to negative ion generator and UV emission tube's (13) automatic circulating controlled circuitry, in charge of this operation of negative ion generator and UV emission tube (13).

Negative ion from the generator could promote biochemistry process in human body (by increasing the amount of negative ions break in). When inhaled increased quantity of negative ions, it could lower the hormonal secretion on depression and fatigue.

The present invention uses UV tube to generate UV with wavelength of 253.7 nanometers, which is able to kill bacteria, virus and mildew in the air. In this modern society, air condition is a must appliance for families, hospitals, senior citizen centers, shopping malls, theaters, restaurants, office buildings, production workshops, elevators, different cars, ships, airplanes, and trains. Functions of Photoelectron Sterilization Air Purifier improve the environments of our lives, habitations, medical treatments, work conditions, shopping and transportations etc.; provides us clean spaces in this constant nature demolishing modern society.

Negative ion from the generator could promote biochemistry process in human body. When inhaled increased quantity of negative ions, it could lower the hormonal secretion on depression and fatigue.

Said air purifier uses UV tube to generate UV with wavelength of 253.7 nanometers, which is able to kill bacteria, virus and mildew in the air. In this modern society, air condition is a must appliance for families, hospitals, senior citizen centers, shopping malls, theaters, restaurants, office buildings, automobile manufacturers, elevators, different cars, ships, airplanes, and trains. Functions of Nano Photoelectron Sterilization Air Purifier improve the environments of our lives, habitations, medical treatments, work conditions, shopping and transportations etc.; provides us clean spaces in this constant nature demolishing modern society.

What is claimed is:

1. An air purifier, comprising:
a three-dimensional housing for actuating an assemblage having a plurality of air inlets and a plurality of air outlets with predetermined sharp, wherein the three-dimensional housing comprises:
at least one extractor fan mean horizontally inserted and engaged in said three-dimensional housing for mean of drawing air into said three-dimensional housing through said air inlet, through a ultraviolet radiation tube mean and out of said housing through said air outlet,
an air aggregator integrally provided between said extractor fan mean and said housing,
a ultraviolet radiation tube mean for generating ultraviolet rays to produce and increase the quantity of anions is integrally connected within said housing, said air inlet and air outlet are connected at both ends of said a ultraviolet radiation tube mean,
an electric circuit with a voltage transformer connected with an indicator light, a starter electrically connected via said electric circuit to said ultraviolet radiation tube,
a switch on said housing electrically connected via said electric circuit between said housing and said air drawing means, and a plug on an electric cord electrically connected to said electric circuit to engage with a wall socket to receive electricity therefrom;
a high negative voltage discharge/carbonated fiber is connected between said ultraviolet radiation tube and said air outlet.

2. An electric-optical air purifier, which comprises:
an air ventilator,
an UV emission tube, and negative high voltage electrical carbonization fiber, wherein, when air is drawn into said air purifier through its ventilator, it goes through two different constant circulating processes; and
said circulating process further comprises:
a first process is to exercise negative high voltage on carbonization fiber to discharge electricity, thus creates negative ions and then emanates the air through vent; and
a second process sets off UV to kill bacteria, virus and mildew, there is a one incoming air vent and one outgoing air vent; said high voltage carbonization fiber is fixed inside of an outgoing air vent, while said UV emission tube is located within said incoming air vent; said air ventilator is positioned inside of said air purifier, taking in regular air with bacteria, virus, and mildew to said air purifier, thereby it drives the moving air through said air purifier, forcing air with bacteria, virus and mildew to contact said UV tube, so that UV could perish bacteria, virus and mildew first, and then it pushes the air through the purification process of negative ionization and finally emanates fresh air with negative ion to improve the indoor air quality, wherein said electronic circuit system further comprises:
an anion generating circuit, and
an ultraviolet radiation tube generating 253.7 nm start-up circuit.

3. As recited in claim 2, said electronic circuit system is characterized by a high negative voltage output volume as stated, i.e. within the range of 4.5 kv and 8.5 kv.

4. As recited in claim 2, said electronic circuit system is characterized by a variable resistor functions of said anion generating circuit, i.e. to adjust high negative voltage output volume.

5. As recited in claim 2, said electronic circuit system is characterized by a variable resistor functions of said ultraviolet radiation tube generating 253.7 nm start-up circuit, i.e. to adjust high negative voltage output volume.

6. As recited in claim 2, said electronic circuit system is characterized by the fact that said air purifier works in two alternate modes in loop. Said two alternate modes in loops further comprises of:
first mode is to output high negative voltage intermittently (about 3 to 4 minutes between each interception) via said carbonated fiber discharge, said anions produced is then blown out through said extractor fan.
second mode is to ignite the extreme ultraviolet radiation intermittently (about 7 to 10 minutes between each interception) to eliminate the germs, viruses, funguses and other harmful airborne microorganisms or particles in the air. User may operate independently and continuously in mode 1 and/or mode 2.

7. As recited in claim 1, there are fences at both front and rear portions of said air aggregator, wherein said fences keep said extreme ultraviolet radiations from radiating beyond said housing 1, so as to protect the eyes of the user.

8. An air purifier as recited in claim 1, comprises:
a three dimensional housing and inlet and outlet bars, which is mounted to the front plane of said body, and
an inlet frame grid is mounted to a front plane portion of frame grid, and
an ultraviolet radioactive ray chamber is located within a triangle in a center position of a filter frame grid, and
a contact chips at both front and rear portions of ultraviolet radioactive ray chamber are connecting to an external power via terminal box, while said ultraviolet radioactive ray chamber fastens a front frame grid and an rear frame grid in a half-circle, and
a carbon fibers are fastened within an extended pit of a front frame grid, and
anion-generating circuit, and
a front frame grid further comprises
a circuit board, electronic components, and external power line; and
on a side face of a front frame grid, there is a rectangular hole-site which fastens said external power line. A switch is connected to a central section of said external power line.

9. An electronic circuit system as recited in claim 2, an ultraviolet radioactive ray chamber produces 253.7 nanometers of waves to active an electronic circuit.

10. An air purifier as recited in claim 8, an ultraviolet radioactive ray chamber produces 253.7 nanometers of waves to active an electronic circuit.

11. An electronic circuit system as recited in claim 2, such electronic circuit is distinguished by its negative high voltage output value between 4.5 kv to 8.5 kv.

12. An air purifier as recited in claim 8, such electronic circuit is distinguished by its negative high voltage output value between 4.5 kv to 8.5 kv.

13. An electronic circuit system as recited in claim 1, such electronic circuit is having variable resistor effect created by the anion-generating circuit is to adjust negative high voltage output value.

14. An air purifier as recited in claim 2, such electronic circuit is having variable resistor effect created by the anion-generating circuit is to adjust negative high voltage output value

15. An electronic circuit system as recited in claim 1, wherein said air purifier can adapt both conventional indoor power supply and power generated by any transportation vehicles.

16. An air purifier as recited in claim 2, wherein said air purifier can adapt both conventional indoor power supply and power generated by any transportation vehicles.

17. An air purifier as recited in claim 1, wherein said the UV tube and said dust filtration screen provide means of replacement.

18. An air purifier as recited in claim 2, wherein said the UV tube and said dust filtration screen provide means of replacement.

19. An air purifier as recite in claim 1, a three dimensional housing and inlet and outlet bars, which is mounted to the front plane of said body, and
an inlet frame grid is mounted to a front plane portion of frame grid, and
an ultraviolet radioactive ray chamber is located within a triangle in a center position of a filter frame grid, and
a contact chips at both front and rear portions of ultraviolet radioactive ray chamber are connecting to an external power via terminal box, while said ultraviolet radioactive ray chamber fastens a front frame grid and an rear frame grid in a half-circle, and
a carbon fibers are fastened within an extended pit of a front frame grid, and
a front frame grid further comprises
a circuit board, electronic components, and external power line; and
on a side face of a front frame grid, there is a rectangular hole-site which fastens said external power line. A switch is connected to a central section of said external power line.

20. An air purifier as recite in claim 2, a three dimensional housing and inlet and outlet bars, which is mounted to the front plane of said body, and
an inlet frame grid is mounted to a front plane portion of frame grid, and
an ultraviolet radioactive ray chamber is located within a triangle in a center position of a filter frame grid, and
a contact chips at both front and rear portions of ultraviolet radioactive ray chamber are connecting to an external power via terminal box, while said ultraviolet radioactive ray chamber fastens a front frame grid and an rear frame grid in a half-circle, and
a carbon fibers are fastened within an extended pit of a front frame grid, and
a front frame grid further comprises
a circuit board, electronic components, and external power line; and
on a side face of a front frame grid, there is a rectangular hole-site which fastens said external power line. A switch is connected to a central section of said external power line.
